(19) United States
(12) Patent Application Publication
(10) Pub. No.: US 2013/0220049 A1
(43) Pub. Date: Aug. 29, 2013

(54) Method for Producing High-Strength Components by Means of Adiabatic Blanking

(71) Applicants: Hans-Georg Werner, Langenfeld (DE); Bernd Gross, Langenfeld (DE)

(72) Inventors: Hans-Georg Werner, Langenfeld (DE); Bernd Gross, Langenfeld (DE)

(73) Assignee: Johnson Controls GmbH, Burscheid, MI (US)

(21) Appl. No.: 13/577,548

(22) PCT Filed: Feb. 8, 2011
(86) PCT No.: PCT/EP2011/000575

§ 371 Date: Oct. 26, 2012

(30) Foreign Application Priority Data
Feb. 12, 2010 (DE) 10 2010 007 955.3

(51) Int. Cl. B21D 22/02; F16H 55/06; B21B 1/00

(52) U.S. Cl. CPC B21D 22/02; B21B 1/00; F16H 55/06
USPC 74/437; 72/362; 72/379.2; 72/365.2; 72/372; 72/462

(57) ABSTRACT

The present invention relates to a method for producing a component of an adjustment device for vehicle seats, wherein, in a first step, a work piece is machined such that the work piece is harder in a first region than in a second region, and/or in that the work piece is of a larger geometrical size in a third region than in a fourth region, wherein, in a second step, the work piece is deformed in such a way that a tool is moved onto the work piece at a speed greater than 1 m/s.

The present invention relates to a method for producing a component of an adjusting device for vehicle seats, wherein in a first a step a workpiece is machined such that the workpiece is harder in a first region than in a second region and/or such that the workpiece has a larger geometric dimension in a third region than in a fourth region, wherein in a second step the workpiece is shaped in such a way that a tool is moved onto the workpiece at a speed greater than 1 m/s.

Methods for producing components are well known. Furthermore., the documents EP 1 516 717 A1, WO 2007/026091 A1 and WO 2007/026 090 A1 disclose methods and devices which use the principle of adiabatic separation. In the principle of adiabatic separation, a tool is moved at high speed onto a workpiece, such that the component is stamped out with the development of heat at the separating edges. What is disadvantageous with the known methods and devices is that reworking, e.g. hardening of the surface of the component, has to take place after the stamping operation, in order to produce high-strength components.

It is therefore the object of the present invention to provide a method which does not have the disadvantage of conventional methods.

This object is achieved in that a method for producing a component of an adjusting device for vehicle seats is made available, wherein in a first step a workpiece is machined such that the workpiece is harder in a first region than in a second region and/or such that the workpiece has a larger geometric dimension in a third region than in a fourth region, wherein in a second step the workpiece is shaped in such a way that a tool is moved onto the workpiece at a speed greater than 1 m/s. According to the invention, in the first method step
local hardening can take place or
a local or regional change in a geometric dimension can be carried out, or else
both local hardening and a local or regional change in a geometric dimension can be carried out (for instance the local hardening in a first part-step of the first method step and the ideal or regional change in a geometric dimension in a second part-step of the first method step).
   As a result, it is possible for only the first and the second region to be created (if only local hardening in the first region is carried out) or for only the third and the fourth region to be created (if only a local or regional change in a geometric dimension in the third or fourth region is carried out). It is preferably provided according to the invention that both local hardening and a local or regional change in a geometric dissension are carried out. Thus, both a first and second region (with regard to the different hardness) and a third and fourth region (with regard to the geometric dimension) are produced, wherein the first region can overlap the third or fourth region and wherein the second region can overlap the third or fourth region. The first region is produced preferably by hardening the workpiece surface (local hardening). Both the third region and the fourth region are produced preferably by a rolling method, such that the rolling produces preferably a smaller material thickness of the workpiece in the fourth region than in the third region.

A geometric dimension is any measurable extent of the workpiece, such as the thickness of a strip material, for example. Material in the context of this invention is any metallic material which can be treated with the machining method. Tool in the context of this invention is any means for machining a workpiece. Shaping in the context of this invention is any machining, operation on the workpiece, in which the shape of the workpiece before the operation differs from the shape of the workpiece after the operation.

Compared with the prior art, the method according to the invention has the advantage that as a result of shaping at high speed, an optimum form of the component, such as a toothing, for example, can be achieved and at the same time regions of the coupon exit having different hardnesses and/or thicknesses can be realised, without complicated reworking steps for hardening being necessary. As a result, production costs can be lowered and the weight of the component reduced. Furthermore, no use of lubricant is necessary during machining, and so advantageously much simpler production is possible and no reworking, such as cleaning lubricant off the component or deburring, for example, is necessary. On account of the high impact speed of the tool, the material is transferred into an adiabatic state in which, for example, the formation or production of the toothing takes place. In this case, the atomic cohesion of the metal workpiece is reduced, so that the latter can flow more easily during shaping. Therefore, the shaping process is substantially non-cutting and so advantageously the non-cutting production can considerably reduce the manufacturing outlay and better material utilization is possible. Furthermore, it is advantageously possible to achieve comparatively good material utilisation on account of the small deformation of the edge regions. Furthermore, it is advantageously possible for a comparatively good toothing quality to be achieved. In addition, a very high efficiency results compared with known methods such as the milling of a toothing. Furthermore, tool loading in the method according to the invention is comparatively low compared with extrusion or forging, resulting in considerably longer service lives of the tool and the machine.

Preferably, the tool has a voiding support and a molding punch, wherein the shaping takes place with a high impact speed of the molding punch against the workpiece placed on the molding support. The impact speed or the folding punch is preferably more than 3 m/s, more preferably more than 6 m/s, more preferably more than 3 m/s.

Furthermore, on account of the rolling and/or hardening prior to the adiabatic shaping process, it is advantageously possible for a component for an adjusting device to be producible in a simple manner, said component having regions having different hardnesses and/or regions having different thicknesses. Reworking is no longer necessary, since a hardening process is no longer required. Preferably, the workpiece is in the form of strip material. More preferably, the strip material is in the form of a plate. More preferably, the strip material is unrolled from a roll. By way of the method according to the invention, it is possible in an easy manner to produce for example toothings of latching pawls or gear sector plates, which require great hardness and high strength. Preferably, it is possible for a fitting part, a blocking cam, toothed segments, locking hooks or pinions to he producible by means of the method according to the invention. The hardening of the workpiece prior to stamping is carried cut for example by a laser, by way of which the workpiece is selectively locally heated, such that comparatively little material distortion occurs. Preferably, a fiber laser is used. As a result, manufacturing processes are saved and the production costs are considerably reduced. It is furthermore advantageous that less stressed regions can be configured in a thinner manner, as a result of which material can be waved and so the weight of the component can he reduced and the material costs per component can be considerably lowered. At the same time, the required strength of the component in specific regions can be produced in an easy manner. Furthermore it is advantageously possible that comparatively thick workpieces can also be stamped with the method according to the invention on account of the high tool speed. Preferably a steel material is used as material, more preferably a high-strength or ultra-high-strength steel material, more preferably an MnCr steel alloy such as high-strength 16MnCr5 steel, for example. However, any other steel material can also be used. Preferably, the workpiece has a thickness of 5 mm in a thicker region and a thickness of 4 mm in a thinner region, wherein any other combination of thin and thick material can also be realized. Furthermore, it is possible to combine both regions having different thicknesses and regions having different hardnesses, such that advantageously a large number of possible components having different materials properties can be realised. Preferably, the component is punched from a strip-like workpiece, wherein, by suitable arrangement of regions of different thickness and hardness, it is possible to manufacture components with optimum utilization of the material strip, as a result of which wastage of material can be reduced. Preferably, the adiabatic shaping takes place at a cycle frequency of 30 to 200 workpieces per minute, more preferably 50 to 160 workpieces per minute, more preferably 70 to 130, more preferably 80 to 110 workpieces per minute.

A further subject of the present invention is a component of an adjusting device for vehicle seats, produced by one of the above methods, wherein the component has a hardened toothing and/or a hardened bearing point.

A further subject of the present invention is a device for carrying out the method according to the invention, wherein the device has a high-speed press for stamping the component out of the workpiece. Preferably, the impact speed of the tool onto the workpiece is greater than 1 m/s, preferably greater than 3 m/s, preferably greater than 5 m/s, more preferably greater than 7 m/s, more preferably greater than 9 m/s. It is more preferable that the device is configured for 20 to 200 stamping movements per minute, more preferably 58 to 160 stamping movements per minute, more preferably 70 to 130, more preferably 80 to 110 stamping movements per minute.

The invention is explained by way of the following figures. These explanations are merely by way of example and do not limit the general concept of the invention.

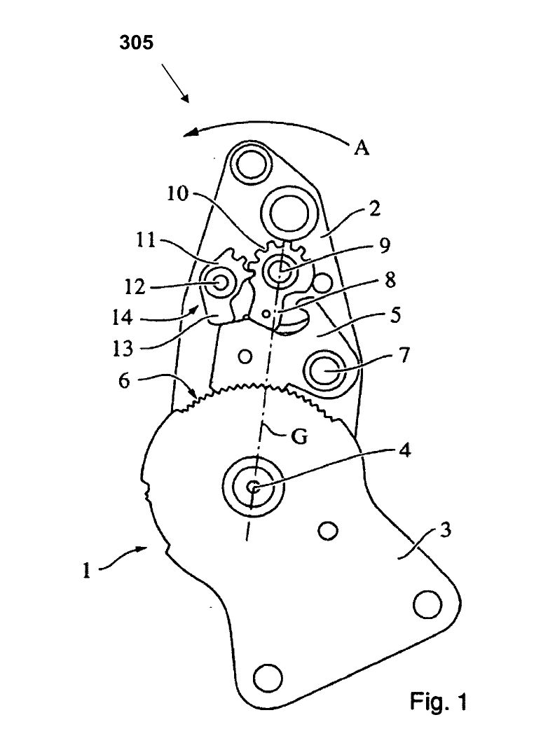

FIG. 1 schematically shows a blocking and inclination adjusting device having a latching pawl according to the invention in the locked state.

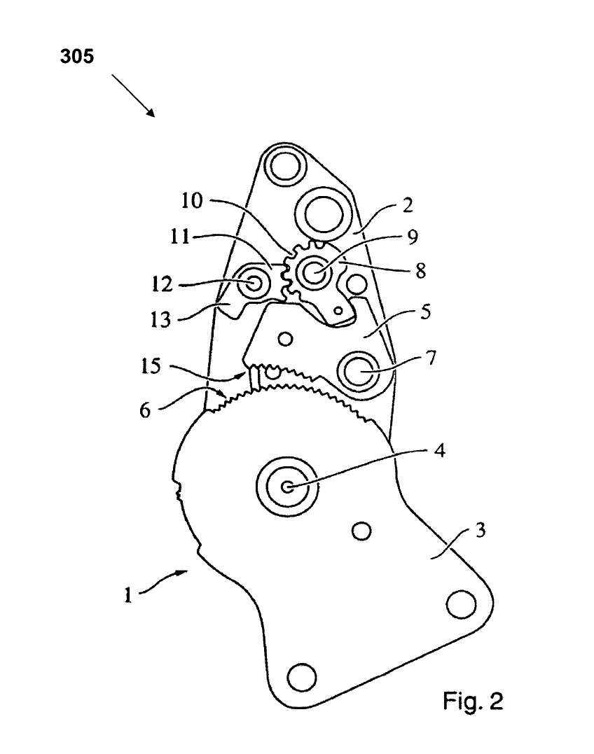

FIG. 2 schematically shows the blocking and inclination adjusting device having the latching pawl according to the invention in the unlocked state.

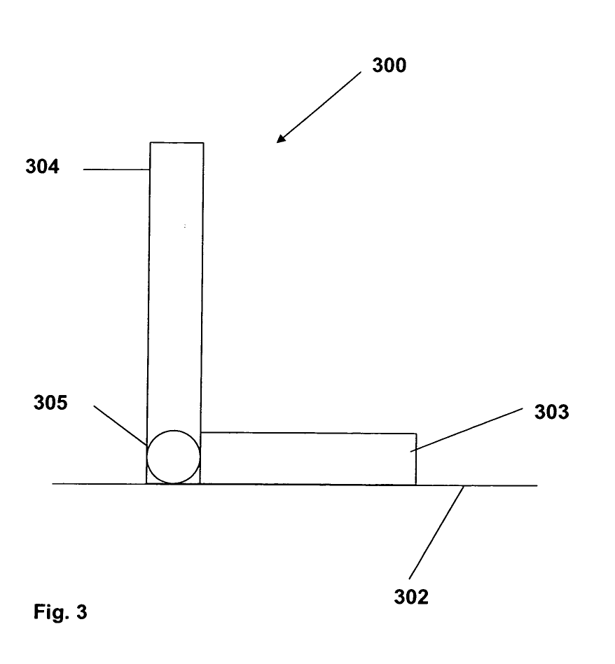

FIG. 3 schematically shows a seat which is controlled by way of the blocking and inclination adjusting device having the latching pawl according to the invention.

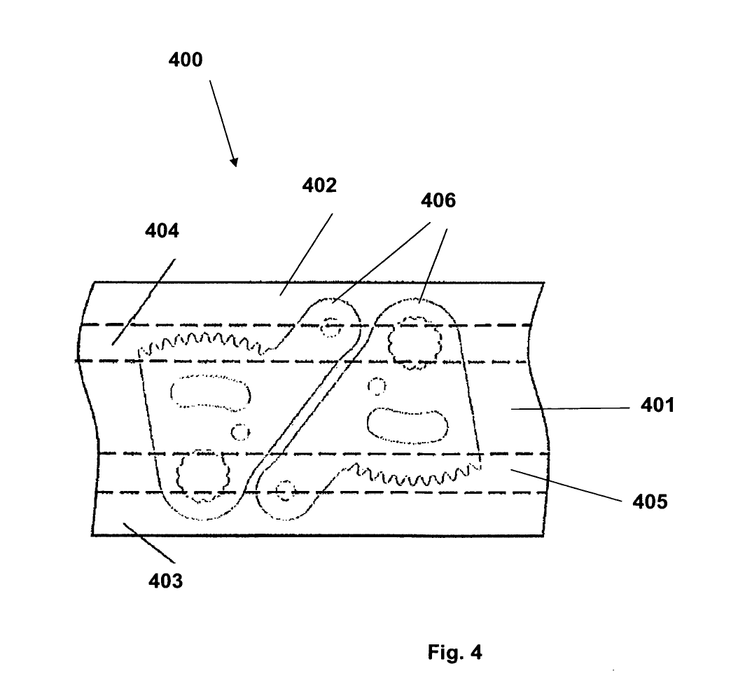

FIG. 4 schematically shows an embodiment of the method according to the invention.

FIG. 1 schematically shows a blocking and inclination adjusting device having a latching pawl according to the invention in the looked state. The fitting 1 consists of a first fitting part 2 and a second fitting part 3 which, are rot at able with respect to one another about a rotation axis 4. The second fitting part 3 is for example arranged on the seat part and the fitting part 2 on the backrest of a vehicle seat or vice versa. Locking is carried out by engagement of the mating toothing is of the latching pawl 5 info the toothing 6 of the second fitting part 3. The latching pawl 5 is arranged on the fitting part 2 so as to be rotatable about an axis 7 and is clamped in the toothing 6 by the blocking cam 8 and secured in this position. The blocking cam 8 that hears against the circumference of the latching pawl 5 rotates with respect to the fitting part 2 about a rotation, axis 9 and is engaged with a pinion 11 via a partial circumferential toothing 10, said pinion 11 having a protrusion 13 directed in the direction of the latching pawl 5 and thus serving at the same time as a blocking element (auxiliary cam 14) for the latter. The rotation axis 12 of the auxiliary cam 14 is arranged at a distance from the rotation axis 9 of the blocking cam 8, specifically in the direction of that end of the latching pawl 5 that is opposite the rotation axis 7. The rotation axis 13 is thus, as seen from the rotation axis 7, located on the other side of a straight line G connecting the rotation axes 4 and 9. In the exemplary embodiment, the auxiliary cam 14 is not located directly at the circumference of the latching pawl 5 but has a small gap with respect to the latter. However, it would also be conceivable to allow the auxiliary cam 14 to bear against the latching pawl 5 and to provide the blocking cam 8 with a gap. The blocking cam 8 is prestressed so as to rotate in the clockwise direction and the auxiliary cam 14 is prestressed so as rotate in the counterclockwise direction. The blocking cam 8 and auxiliary cam 14 are prestressed via a spring (not illustrated) which acts on the blocking cam 8 and the force of which is transmitted via the toothing 10 onto the auxiliary cam 14, too.

In the event of a deformation, caused by an accident, of the teeth of the latching pawl 5, the auxiliary cam 14 and the blocking cam 8 are both braced against the circumference of the latching pawl 5 and prevent it from opening. In the process, the gap previously provided by the design is closed. The contact point of the auxiliary cam 14 with the latching pawl 5 is in this case selected such that the tooth engagement between the toothing 6 and the latching pawl 5 is promoted to a considerable degree in the event of a forwardly directed loading of the fitting 1 (arrow A).

FIG. 2 schematically shows the deliberate opening of the fitting 1 in order to set the inclination position by previously known rotation of the blocking cam 8 counter to its prestressing direction. Arranged on the auxiliary cam 14 is a handle (not illustrated), by way of which said auxiliary cam 14 is rotated in the clockwise direction. In the process, its protrusion 13 is rotated away from the latching pawl 5 and the rotary movement is transferred to the blocking cam 8, so that the latter is likewise rotated way from the latching pawl 5 in the counterclockwise direction. However, the handle can also be arranged on the blocking cam 8.

FIG. 3 schematically shows a seat 300 which is operated by way of the blocking and inclination adjusting device 305 having the latching pawl 5 according to the invention. A backrest part 304 is connected to a body 302 of a vehicle via the blocking and inclination adjusting device 305. Preferably, the seat 300 is adjustable along two rails which are arranged on the body 302. Preferably, it is possible for a seat part 303 and the backrest part 304 to connected to one another via the blocking and inclination adjusting device 305 such that the inclination of the backrest part 304 can be changed with respect to the seat part 303.

FIG. 4 schematically shows an embodiment of the method according to the invention. First of all, the workpiece 400 is rolled such that in the region 401 (the regions are indicated by dashed lines) there is a smaller material thickness than in the regions 402 and 403. As a result, material can be saved and the weight of the component reduced. Next, the workpiece is hardened in the regions 404 and 405, which are in the regions 402 and 403, respectively, by local heating for example by a fiber laser. Next, the workpiece is placed on a tool lower part which has two recesses 406 (illustrated by thin lines) in the negative form of the Component. These recesses 406 are arranged such that the workpiece 400 is utilised to the best possible extent and as little scrap as possible is produced. Next, two molding punches (not illustrated here), which have the shape of the component are moved at full speed onto the workpiece lower part. As a result, two components according to the invention are stamped out of the workpiece 400. Subsequent hardening is not longer necessary.

### LIST OF REFERENCE SIGNS

1 Fitting

2, 3 Fitting, part

4 Rotation axis (between the fitting parts 2, 3)

5 Latching member, latching pawl

6 Toothing (of the fitting part 3)

7 Rotation axis (of the latching pawl 5)

8 Blocking cat

9 Rotation axis (of the blocking cam 8)

10 Toothing (of the blocking cam 8)

11 Pinion

12 Rotation axis (of the pinion 11)

13 Protrusion

14 Blocking cam, auxiliary cam

15 Toothing of the latching pawl

300 Seat

302 Body

303 Seat part

304 Backrest part

305 Blocking and inclination adjusting device

400 Workpiece

401, 402, 403, 404, 405 Regions of the workpiece

406 Recesses

1. A method for producing a component of ah adjusting device for vehicle seats, characterized in that in a first a step a workpiece is machined such that the workpiece is harder in a first region than in a second region and/or such that the workpiece has a larger geometric dimension in a third region than in a fourth region, wherein in a second step the workpiece is shaped in such a way that a tool, is moved onto the workpiece at a speed greater than 1 m/s.

2. The method as claimed in claim 1, characterized in that the tool is moved onto the workpiece at a speed greater than 3 m/s.

3. The method as claimed claim 1, characterized in that the workpiece is present in the form of a plate or of unrolled strip material.

4. The method as claimed in claim 1, characterized in that the workpiece comprises a steel material.

5. The method as claimed in claim 1, characterized in that in the first step first of all the workpiece is rolled and after the rolling the first region of the workpiece is hardened.

6. The method as claimed in claim 1, Characterized in that in the second step the workpiece is stamped with a high-speed press.

7. A component of an adjusting device for vehicle seats, produced by a method as claimed in claim 1, characterized in that the component has a hardened toothing and/or a hardened bearing point in the first region.

8. A device for carrying out a method as claimed in claim 1, characterized in that the device has a high-speed press for stamping the component out of the workpiece.

9. The device as claimed in claim 8, characterized in that the impact speed of the tool on the workpiece is greater than 1 m/s.

10. The device as claimed in claim 8, characterized in that the device is configured for 30 to 200 stamping movements per minute.
